(19) United States
(12) Patent Application Publication
(10) Pub. No.: US 2003/0145674 A1
(43) Pub. Date: Aug. 7, 2003

(54) Robot

(75) Inventor: William T. Weaver, Austin, TX (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 10/072,781

(22) Filed: Feb. 7, 2002

(51) Int. Cl. B25J 17/00

(52) U.S. Cl. 74/490.01

(57) ABSTRACT

The robot includes a substantially vertical linear track and a bearing configured to translate along the linear track. Also included is an elongate arm having opposing first and second ends. The elongate arm is rotatably coupled to the bearing near the first end. A platform, configured to receive a wafer handling robot, is rotatably coupled to the elongate arm near the second end of the elongate arm. A linear drive, configured to translate the bearing along the linear track, is coupled to the bearing.

### BACKGROUND OF THE INVENTION

1. Field of the Invention

The present invention relates to an electro-mechanical robot (hereafter “robot”). More specifically, this invention pertains to a robot having a single automated linkage arm, where the robot is preferably used in semiconductor fabrication.

2. Description of Related Art

Generally, robots are stand-alone hybrid computer systems that perform physical and computational activities. They are typically multiple-motion devices with one or more arms and joints that are capable of performing many different tasks and usually include a computer that directs the physical actions of the robot's arms and joints by pulsing motors connected to the robot's arms and joints.

Robots are used in numerous industries and in a variety of different capacities. For example, robots are used in the automotive industry, in fabrication plants, and in the electronics industry. They are employed to lift objects, transport objects, align objects, assemble components, or the like. Furthermore, robots are particularly suited to do repetitive tasks quickly, less expensively, more accurately, and under exacting environmental conditions, such as high heat and hazardous chemical environments.

A particularly good example of robots employed under adverse environmental conditions is the wafer handling robots used in the semiconductor industry. These robots typically operate in a vacuum and must be compact, accurate, strong, reliable, speedy, and tolerate numerous adverse chemical and thermal conditions.

In particular, wafer handling robots must not introduce or generate particulates through wear or maintenance that might contaminate the ultra-clean fabrication environment and potentially damage the wafer. Furthermore, each processing step of the fabricating process has its own particular hazardous environmental conditions to which the robot is exposed. In addition, these wafer handling robots must also handle the costly wafers delicately, as they are easily damaged or destroyed.

Furthermore, as semiconductors have become more of a fungible commodity there is an ever increasing push to expand the profitability of semiconductor fabrication plants through an increase in wafer throughput. At the same time, wafer size has also been increasing to boost the number of semiconductors per wafer, thereby further increasing throughput. Furthermore, the wafer handling robots must also take up as small a physical footprint on the factory floor as possible so that further robots can be added, thereby increasing throughput even further. These increased demands place higher loads on the wafer handling robots, which now need to carry larger and heavier wafers, over a longer distance, and in a quicker time. Therefore, modern wafer handling robots must be strong enough to accomplish their increased workloads without becoming adversely large and bulky.

A number of prior art wafer handling robots have attempted to address some of the above mentioned heightened robot requirements. Examples of cluster tool wafer handling robots can be found in U.S. Pat. Nos. 4,735,548; 4,778,331; 6,048,162; and 6,208,751 all of which are incorporated herein by reference. FIG. 1A is a diagrammatic plan view of a typical prior art cluster tool 1, as shown and described in U.S. Pat. No. 6,048,162. Processing chambers 2, 4, 6, and 8 are arranged radially around a wafer handling robot 10. Wafer handling robot 10 can rotate and extend to position a wafer carrying end effector 18 into any of the chambers 2, 4, 6, and 8. This wafer handling robot 10 is typically knows as a single arm Selectively Compliant Articulated Robot Arm (SCARA). The operational envelope in which the wafer handling robot 10 can operate is shown by circular area 22.

The wafer handling robot 10 consists of linkage arms 12, 14, and 16. Linkage arms 12 and 14 are rotatable relative to one another. Rotational drives (not shown) rotate the linkage arms 12, and 14 to move the end effector from process chamber to process chamber. Rotational drives (not shown) also rotate the linkage arms 12, and 14 to translate the end effector 18 into and out of the process chambers 2, 4, 6, and 8 for deposition and retrieval of wafers 20. A typical cycle of operation for wafer handling robot 10 is initiated with the rotation of the wafer handling robot 10 into alignment with a process chamber 2, 4, 6, or 8 where a wafer is to be deposited or retrieved. The end effector 18 is then extended to deposit or retrieve a wafer 20. Subsequently the end effector 18 is retracted and the wafer handling robot 10 is rotated to another process chamber. However, due to size restrictions this design only allows for a limited number of processing chambers to be arranged around a central wafer handling robot. The design does not scale well to allow additional process chambers to be added to existing cluster tools.

Also, the numerous moveable components, drive assemblies, and linkage arms lead to a high rate of wear, loosening of components, inaccuracy of wafer placement, particle generation, and component failure, all of which result in machine down time, damaged or destroyed wafers and high operating expenses.

FIG. 1B is a diagrammatic plan view of another prior art wafer handling robot 22, similar to the robot disclosed in U.S. Pat. No. 6,208,751. In an attempt to increase the reach of a wafer handling robot 22, the wafer handling robot 22 was placed on a linear track 24. This allows the wafer handling robot 22 to not only rotate about a fixed axis, as described in relation to the wafer handling robot 10 in FIG. 1A above, but also to translate along the linear track 24. Use of the linear track 24 expands the operational envelope 26 of this wafer handling robot 22 to be larger than that of the wafer handling robot 10 (FIG. 1A). However, the linear track 24 tends to attract and trap particles therein. Also, linear track 24 may introduce contaminants into the system as the linear track 24 typically requires lubrication of its bearings together with a translator mechanism, both of which add additional sources of contaminants. Such an arrangement is also more complex and expensive.

Another prior art device, typically referred to as a ‘Cobra’ style robot is disclosed in U.S. Pat. No. 6,234,738. FIG. 1C is an isometric view of a prior art “Cobra” style robot 30, while FIG. 1D is a plan view of the same “Cobra” style robot 30. The “Cobra” style robot 30 comprises a base 32 rotatably coupled to a first end of a first linkage arm 34. A second end of the first linkage arm 34 is rotatably coupled to a first end of a second linkage arm 36. A second end of the second linkage arm 36 is rotatably coupled to a frog-leg type wafer handling robot 40, otherwise known as a dual arm Selectively Compliant Articulated Robot Arm (SCARA). The frog-leg type wafer handling robot 40 performs in a similar manner to the wafer handling robot 10 described above in relation to FIG. 1A. The “Cobra” style robot 30 also includes electric motors 42 and 44 that rotate the linkage arms 34 and 36 relative to the base 32 to translate the frog-leg type wafer handling robot 40 along a linear path 52 (FIG. 1D). Therefore, the frog-leg type wafer handling robot 40 can operate over a much larger operational envelope 50 (FIG. 1D) than the wafer handling robot 10 of FIG. 1A. This allows for more process chambers than the cluster tool 1 (FIG. 1A).

Although this design allows access to more process chambers than the design of FIG. 1A, it too has a number of drawbacks. The “Cobra” style robot 30 includes many large and heavy components including numerous linkage arms and several large and heavy motors, both of which create large moment arms around each of their respective pivot points, especially when the linkage arms are fully extended. This in turn causes wear, loosening of components, particle generation, degradation of the device, and waste of many mishandled and damaged wafers. In addition, the transfer of power to the different motors through each arm is complex. Overall, the high degree of complexity increases the likelihood of mechanical failure.

Moreover, for each cycle, multiple components are rotated or translated which necessitates a more accurate alignment for each component. This in turn leads to inefficient time usage and low throughput.

In light of the above, there is a need for a more scalable wafer handling robot that addresses the above mentioned concerns.

### BRIEF SUMMARY OF THE INVENTION

According to the invention there is provided a robot. The robot includes a substantially vertical linear track and a bearing configured to translate along the linear track. Also included is an elongate arm having opposing first and second ends. The elongate arm is rotatably coupled to the bearing near the first end. A platform, configured to receive a wafer handling robot, is rotatably coupled to the elongate arm near the second end of the elongate arm. A linear drive, configured to translate the bearing along the linear track, is coupled to the bearing.

This robot performs wafer handling in a simpler, cheaper and quicker manner than the prior art devices. For example, the robot functions faster than the multiple link prior art devices because there are less components that move to align the wafer handling robot with a process chamber. As a result of fewer motors, and less complex power transfer mechanisms between components the present invention is more reliable.

Further increasing the reliability, efficiency, and speed of the present invention is the counterbalancing of the components. Counterbalancing of the components allows for faster translation of components because there is less resistance to movement. Less resistance to movement leads to less stress and strain on the motor, power transfer mechanisms, and linkage assemblies resulting in less wear, less debris production, and less failure. This results in a higher throughput for each individual robot. What is more, the small footprint of the present invention allows for more devices per square foot of floor space in a manufacturing facility. This further increases the throughput of each manufacturing facility.

### BRIEF DESCRIPTION OF THE DRAWINGS

For a better understanding of the nature and objects of the invention, reference should be made to the following detailed description, taken in conjunction with the accompanying drawings, in which:

FIG. 1A is a plan view of a prior art cluster tool;

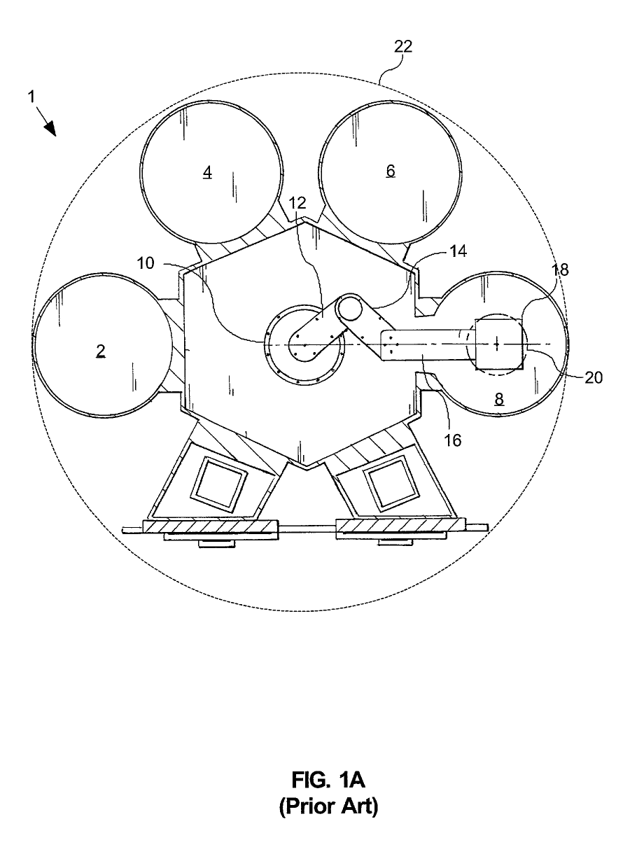

FIG. 1B is a plan view of a prior art wafer handling robot;

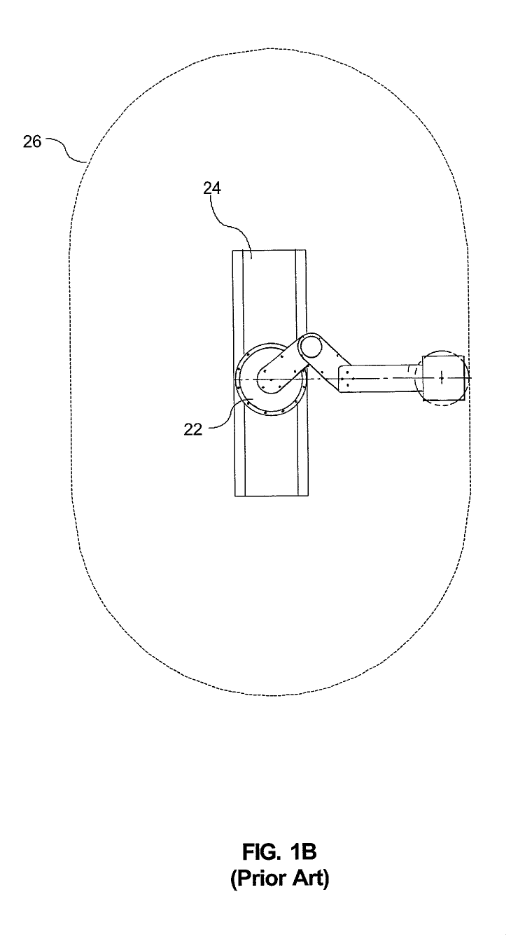

FIG. 1C is an isometric view of a prior art “Cobra” style robot;

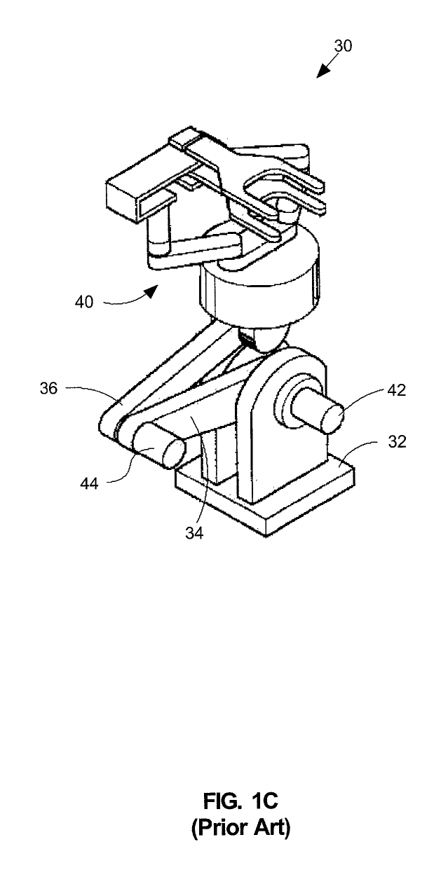

FIG. 1D is a plan view of the prior art “Cobra” style robot shown in FIG. 2A;

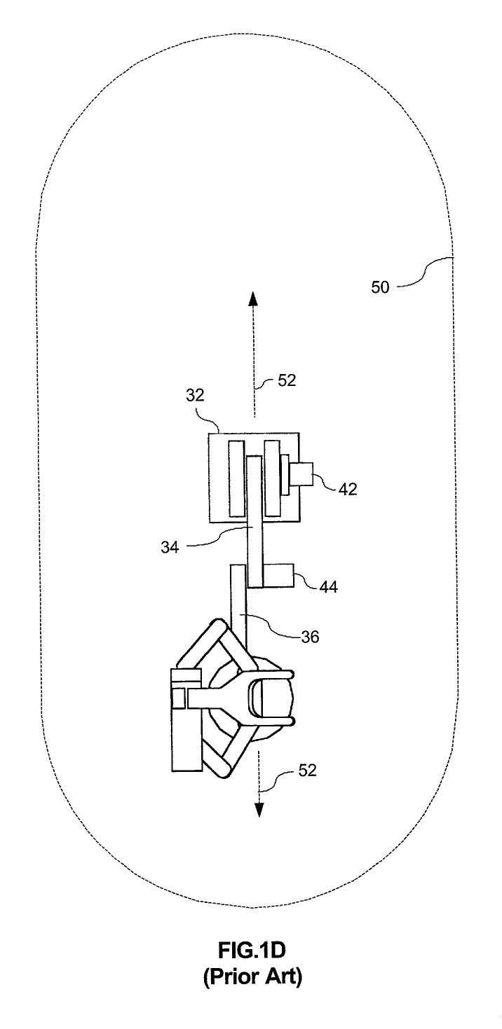

FIG. 2A is a diagrammatic front view of a robot according to an embodiment of the invention;

FIG. 2B is a diagrammatic side view of the robot shown in FIG. 2A;

FIG. 3 is a diagrammatic front view of the robot shown in FIGS. 2A and 2B, where the robot is shown in various positions;

FIG. 4 is a diagrammatic top view of the robot shown in FIGS. 2A and 2B with a wafer handling robot positioned on the platform;

FIG. 5 is a diagrammatic front view of a working envelope of the robot shown in FIGS. 2A and 2B;

FIG. 6 is a diagrammatic close up view of the platform-elongate arm connection illustrating the extent of rotation of the elongate arm;

FIG. 7 is a diagrammatic front view of a rotational counterbalance mechanism according to another embodiment of the invention; and

FIG. 8 is a diagrammatic side view of a linear counterbalance mechanism according to yet another embodiment of the invention.

Like reference numerals refer to corresponding parts throughout the several views of the drawings.

### DETAILED DESCRIPTION OF THE INVENTION

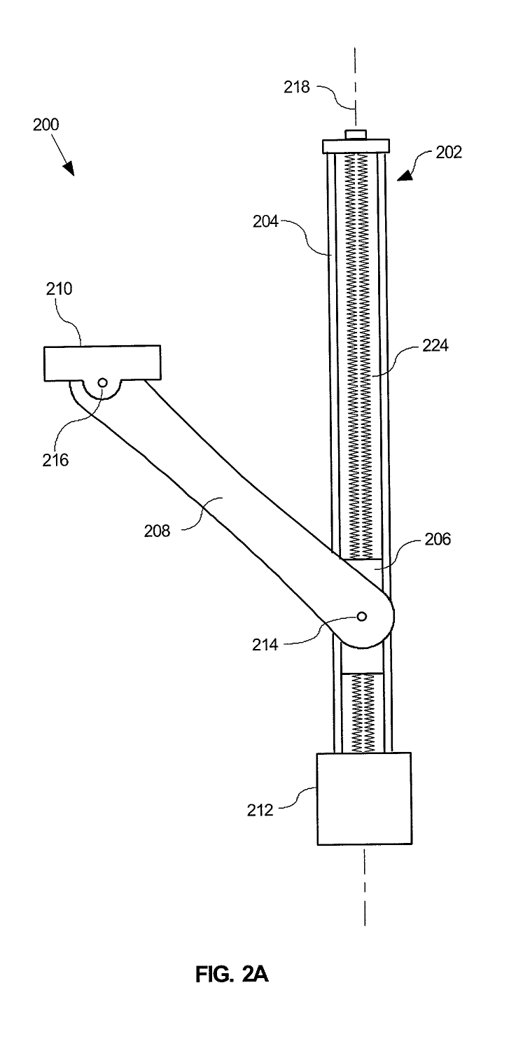

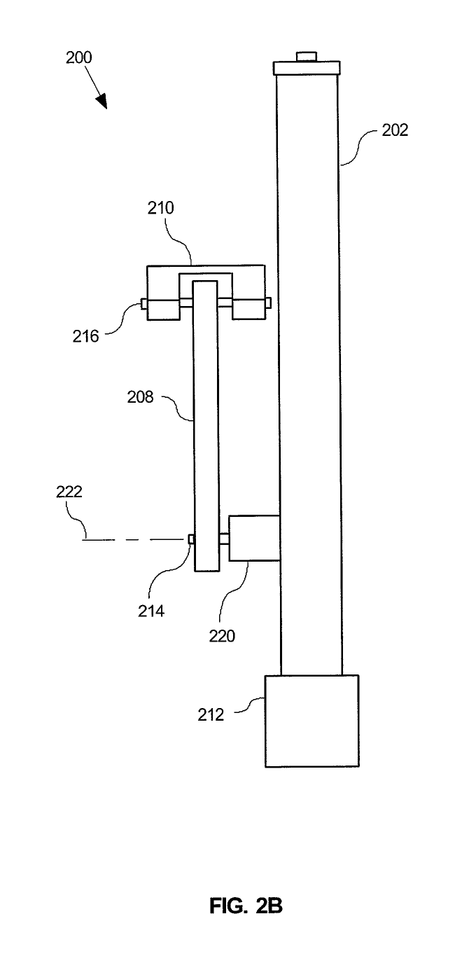

FIG. 2A is a diagrammatic front view of a robot 200 according to an embodiment of the invention, while FIG. 2B is a diagrammatic side view of the robot shown in FIG. 2A. The robot 200 consists of a substantially vertical linear track 202. By vertical it is meant that the longitudinal axis 218 of the linear track 202 is aligned substantially perpendicular to the horizon, and/or that the longitudinal axis 218 is substantially plumb. The robot 200 also includes a bearing 206 configured to translate along the linear track 202. In a preferred embodiment, the linear track 202 comprises one or more rails 204 along which the bearing 206 slides. Suitable linear tracks 202 and bearings 206 are made by Nippon Thompson Co., Ltd. of Tokyo Japan, or THK linear motion systems made by THK America, Inc.

A linear drive 212 is coupled to the bearing 206 to translate the bearing vertically along the linear track 202. The linear drive may be any suitable actuator, such as a lead screw 224 mechanism (shown), a rack-and-pinion mechanism, a stepper motor mechanism, a belt and pulley mechanism, a linear motor mechanism, a servo-pneumatic mechanism, a worm screw mechanism, a ball screw mechanism, a hydraulic mechanism, or the like. A rotary drive 220 (FIG. 2B) is coupled to the bearing 206. The rotary drive 220 is any mechanism that is capable of rotating a shaft 214, such as a stepper motor, servo motor, rotary hydrostatic actuator, hydraulic actuator, or the like. The rotary drive may also include a a gear arrangement, such as harmonic gears, planetary gears, worm gears, or the like. In an alternative embodiment, the linear motion of bearing 206 is converted into a rotational motion at shaft 214 via a rack and pinion mechanism, belt and pulley mechanism, or the like.

The shaft 214 is in turn coupled to a first end of an elongate arm 208. It should, however, be appreciated that the rotary drive 220 may couple directly to the bearing 206 and the elongate arm 208 via a direct drive. However, torque requirements generally make such a direct drive less desirable than coupling the rotary drive 220 to the bearing 206 via gears, pulleys, etc. A as long as the elongate arm 208 can be rotated by the rotary drive 220 about a rotation axis 222 (FIG. 2B).

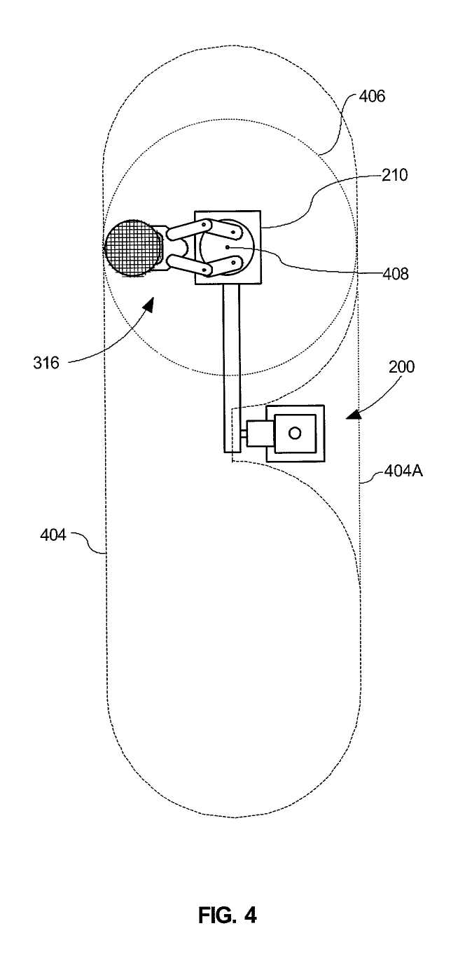

A second end of the elongate arm 208 is rotatably coupled, via a pivot 216, to a platform 210. The platform is preferably configured to receive and hold any type of wafer handling robot, such as a frog-leg type (or single or dual SCARA configuration) wafer handling robot 316, shown in FIG. 4, or the like. The wafer handling robot 316, (FIG. 4), extends into and retracts out of processing chambers (not shown) to exchange wafers during semiconductor processing procedures. The wafer handling robot 316, (FIG. 4), may also be able to rotate around a central axis, 408, (FIG. 4), as explained below in relation to FIG. 4.

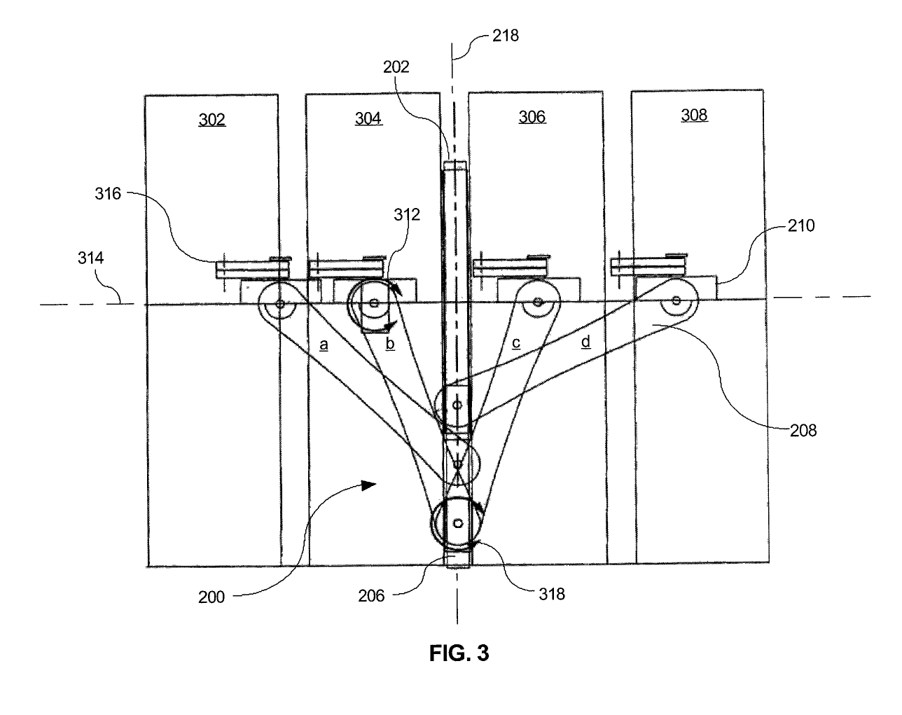

FIG. 3 is a diagrammatic front view of the robot 200 shown in FIGS. 2A and 2B, where the robot 200 is shown in various positions (a, b, c, and d). The robot 200 is preferably used in conjunction with a wafer handling robot 316 to transfer wafers between processing chambers 302, 304, 306, and 308. A loading doors for each of the process chambers 302, 304, 306, and 308 are preferably aligned along a line parallel to horizontal line 314. It should be appreciated that although only a single row of four process chambers 302, 304, 306, and 308 is shown, another row of process chambers opposing the row shown can be positioned on the other side of the robot 200, i.e., out of the page, as well as at either end. Furthermore, although only four process chambers 302, 304, 306, and 308 are shown, it should be appreciated that any number of process chambers can be used by increasing the size of robot 200 accordingly.

Accordingly, to move the platform 210, and hence wafer handling robot 316, from process chamber to process chamber, the robot 200 must translate both along a vertical axis 218 and a horizontal axis 314, (FIG. 2B). For example, to move from position “a” to position “b” the linear drive moves the bearing 206 downward along the linear track 202, while the rotary drive 220 rotates 318 the elongate arm 208 clockwise; to move from position “b” to position “c” the rotary drive further rotates the elongate arm clockwise; and to move from position “c” to position “d” the linear drive moves the bearing 206 upward along the linear track 202, while the rotary drive further rotates the elongate arm clockwise.

Moreover, a stabilizing mechanism 312 couples the platform 210 to the second end of elongate arm 208. The stabilizing mechanism keeps the platform substantially perpendicular to the longitudinal axis 218 of the linear track 202 at all times, i.e., parallel to axis 314. The stabilizing mechanism 312 is any mechanism that rotates the platform 210 by the same amount, but in the opposite direction, as the rotary drive 220 rotates 318 elongate arm 208. This can be accomplished using a pulley mechanism, belt mechanism, chain mechanism, servo motor mechanism, stepper motor mechanism, hydrostatic mechanism, hydraulic mechanism or the like. The stabilizing mechanism may also include any suitable gear arrangement, such as harmonic gears, planetary gears, or the like. In an alternative embodiment, the stabilizing mechanism is independently driven to hold the platform at any desired angle to the longitudinal axis 218. This is particularly useful for auto leveling or compensation as well as other wafer handling situations, such as vertical pick and place stations or stations that require the wafer to be at a certain angle. This approach eliminates the need for an additional rotational axis at the wafer end effector or blade.

FIG. 4 is a diagrammatic top view of robot 200 shown in FIGS. 2A and 2B with wafer handling robot 316 positioned on platform 210. The wafer handling robot 316 shown is a frog-leg type robot that can rotate about a central axis 408. It should however, be appreciated that any suitable wafer handling robot 316 may be positioned on platform 210. Although the operational envelope that the robot operates in is a three dimensional space, only the horizontal cross sectional view of operational envelope 404 is shown here. By selecting the length of linear track 202 (FIGS. 2A and 2B) and the length of elongate arm 208 (FIGS. 2A and 2B) the volume of the robot's operational envelope 404 may be chosen to fit a particular application. Operational envelope 404 of robot 200, in combination with wafer handling robot 316, is much larger than the wafer handling robot's operational envelope 406. By placing loading ports above axis 314 (FIG. 3) and terminating the linear track below axis 314, the operational envelope 404 may be expanded to a larger operational envelope 404A.

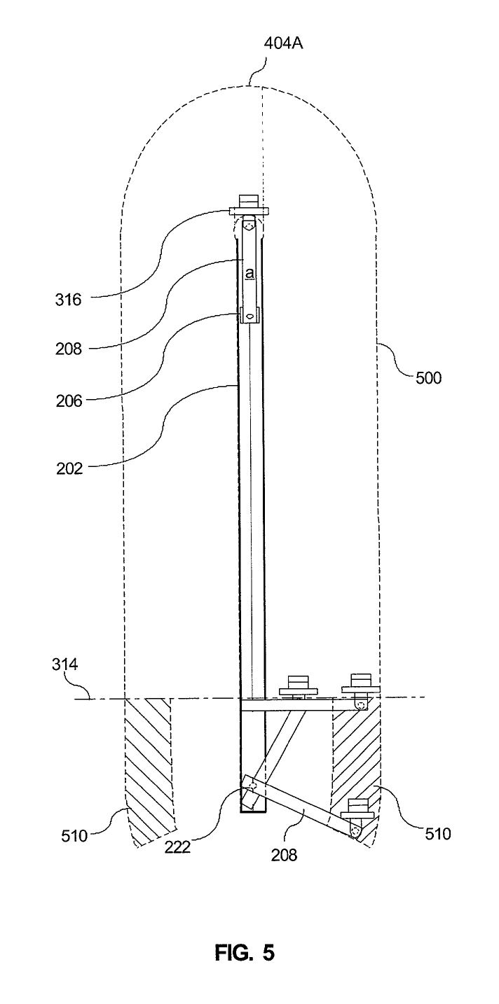

FIG. 5 is a diagrammatic front view of robot 200 showing the vertical operational envelope 500 obtained by the present invention with robot in various positions (e, f, g, and h). The vertical dimension of operational envelope 500 is determined by the length of linear track 202 while the width is determined by the length of elongate arm 208.

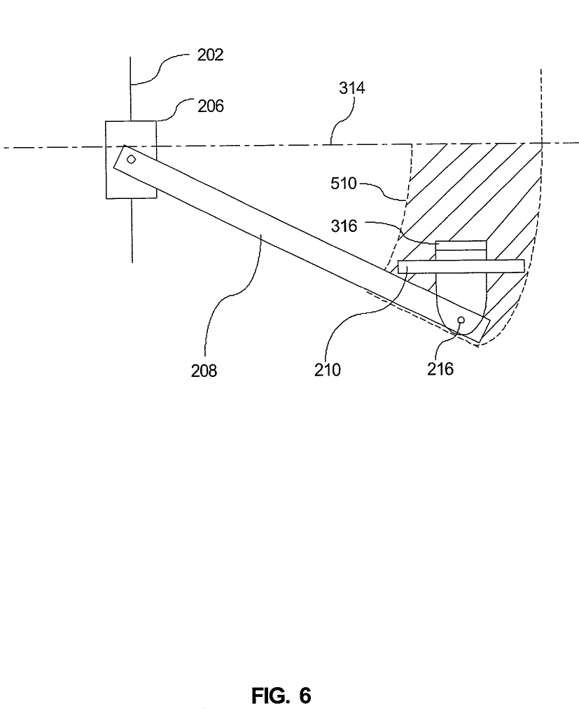

The base of operational envelope 500 is generally set at a particular horizontal plane 314 (FIG. 5). However, operational envelope 500 can be increased at its base to include volume 510 as explained below in relation to FIG. 6.

FIG. 6 is a diagrammatic close up view of the robot in position “h” of FIG. 5 illustrating the extent of rotation of the elongate arm 208. The operational envelope 500 (FIG. 5) can be increased to include area 510 by allowing the elongate arm 208 to rotate below the horizontal and by allowing the platform 210 to rotate to remain parallel to horizontal 314, i.e., horizontal.

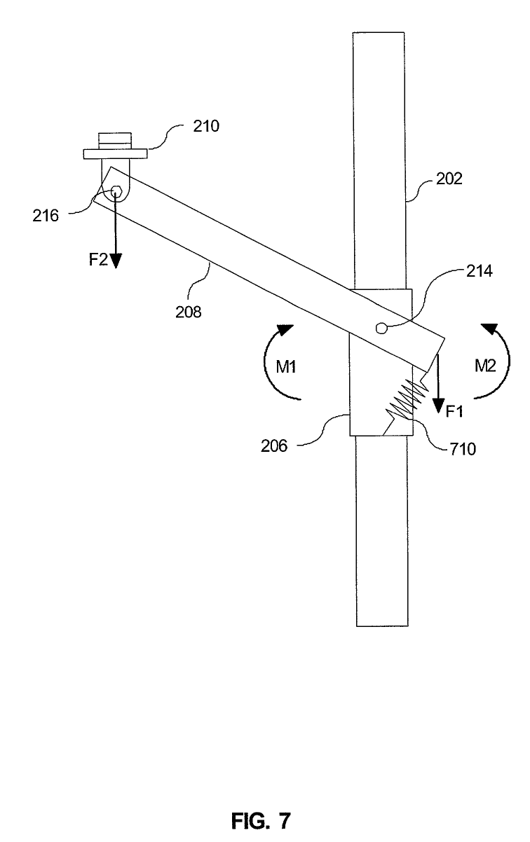

FIG. 7 is a diagrammatic view of the forces applied to elongate arm 208, i.e., static configuration in equilibrium. Elongate arm 208 consists of two ends, a first end and a second end. The first end of elongate arm 208 extends beyond the shaft 214, (FIG. 2A). The weight on the second end of elongate arm 208, generated by weight of the elongate arm, platform, and wafer handling robot at the second end of elongate arm 208, is represented by a force, F2. F2 creates a moment, M2, about shaft 214. To effectively counterbalance this moment M2, a force F1 is applied to the first end of elongate arm 208 creating an equal and opposite moment M1 to moment M2 about shaft 214.

Therefore, elongate arm 208 is rotationally counterbalanced such that work done by rotary drive 220 (FIG. 2B), in rotating elongate arm 208, is minimized. This rotational counterbalance is supplied by a rotational counterbalance mechanism coupled to elongate arm 208. The rotational counterbalance mechanism applies the moment force M1 that is equal and opposite to the moment force, M2.

The rotational counterbalance mechanism is preferably a spring 710 that attaches between the first end of the elongate arm 208 and the bearing 206 at a point below the shaft 214. When elongate arm 208 is vertically aligned with linear track 202, i.e., parallel to the linear track, the spring 710 is in its shortest configuration and preferably does not apply the force F1. As elongate arm 208 rotates about axis 222 (FIG. 2B) on shaft 214, spring 710 is stretched, creating force F1, which induces moment, M1 about shaft 214. By attaching an appropriate spring, moment M1 can be made to be equal and opposite to moment M2 generated by the force F2 at the second end of elongate arm 208. An appropriate spring constant and point of attachment are chosen as to provide rotational counter force for any given rotation of elongate arm 208 about shaft 214.

Alternatively, the rotational counterbalance mechanism may be provided by a mass counter balance, pulley mechanism, spring mechanism, pneumatic mechanism, hydraulic mechanism, or the like.

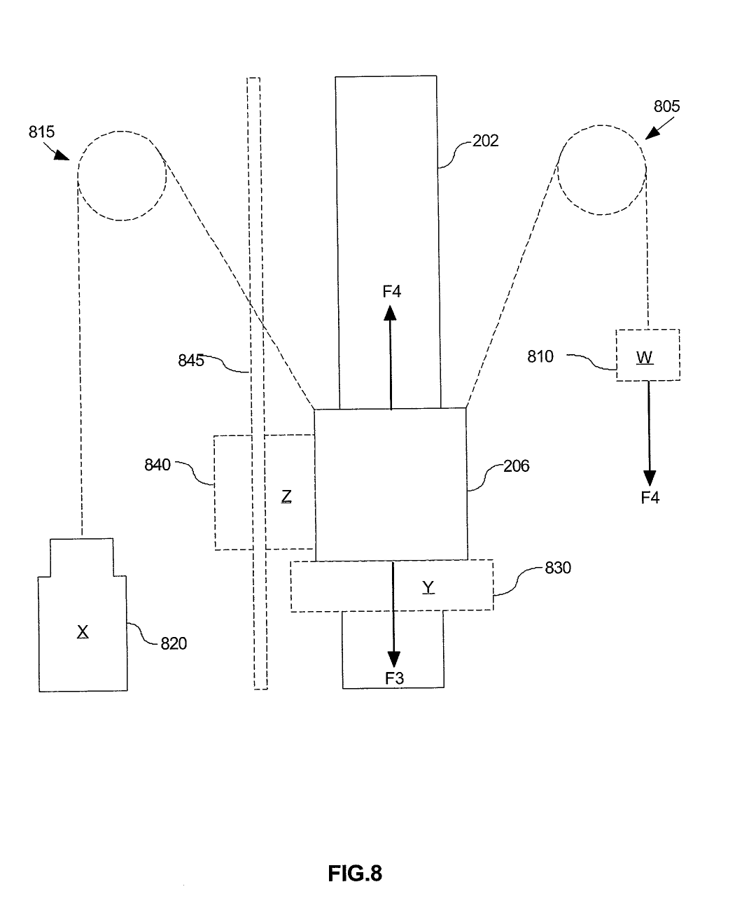

FIG. 8 is a diagrammatic side view of a linear counterbalance mechanism. The linear counterbalance mechanism balances the translation of the bearing 206 along linear track 202, thereby reducing the work done by linear drive 212 to translate the robot vertically along linear track 202. A reduced work load reduces wear and failure of linear drive 212 and increases the overall efficiency of robot 200.

Configuration “W” shows one embodiment of the linear counterbalance mechanism consisting of a weight counterforce mechanism. Configuration “W” preferably consists of a pulley mechanism 805 attached to bearing 206. As linear drive 212 (not shown) moves the bearing 206 up and down the linear track 202, weight 810 attached through the pulley moves to offset and counterbalance the weight of the robot. This enables linear drive 212 (not shown) to be smaller, lighter, more efficient, and less costly to operate. This pulley mechanism 805 has either one cable and pulley attached to bearing 206 or multiple cable and pulley attachments.

Configuration “X” is another embodiment of the present invention where the linear track 202 is counterbalanced. Here, the linear counterbalance mechanism is a counterforce mechanism that consists of cable and pulley mechanism 815 attached to bearing 206 and to pneumatic or vacuum actuator 820. As bearing 206 moves along linear track 202 the pneumatic or vacuum actuator 820 resists or aids linear drive 212 (not shown) in translating the bearing vertically down or up along linear track 202 respectively. This produces a counterbalance effect that reduces the work load on linear drive 212.

Configuration “Y” is yet another embodiment of the present invention where the linear counterbalance mechanism is generated by a counterforce mechanism that consists of a pneumatic cylinder block 830 coupled with bearing 206. Linear track 202 is configured to also function as a pneumatic cylinder rod as well as bearing track for bearing 206. As linear drive 212 (not shown) translates bearing vertically along linear track 202, the pneumatic cylinder block 830 translates along the pneumatic cylinder rod acting as a piston to help raise, and a dampener to help resist the lowering of the robot assembly.

Configuration “Z” is still another embodiment of the present invention where the linear counterbalance mechanism is generated by a counterforce mechanism that consists of pneumatic cylinder block 840, coupled with bearing 206. Pneumatic cylinder block translates along independent cylinder rod 845 adjacent to and parallel with linear track 202. Pneumatic cylinder 840 resists and aids linear drive 212 (not shown) in translating the bearing 206 along the linear track 202.

Alternatively, the linear counterbalance mechanism is generated by a counterforce mechanism that may consists of a pneumatic cylinder block coupled with the robot assembly that translates vertically on a central pneumatic cylinder rod. The robot assembly is supported on bearing trucks that run on bearing rails adjacent and parallel to the central vertical pneumatic cylinder rod. The pneumatic cylinder block and rod provide assistance to linear drive 212 (not shown) in lifting the robot assembly (not shown) and resistance to the lowering of robot assembly. Thus, reducing the size and required power output of the linear drive 212 and creating a more efficient system.

It should be noted that the pneumatic actuator referred to above may be replaced by any suitable linear counterbalance mechanism that performs a similar function. Therefore, the linear counterbalance mechanism could be a pneumatic mechanism, a hydraulic mechanism, a vacuum mechanism, a spring mechanism, or the like. Any type of system that adds resistance to lowering and assistance to raising an object will satisfy the vertical linear counterbalance mechanism of the present invention.

In conclusion, the present invention introduces many advantages over the prior art, namely it performs wafer handling in a simpler, cheaper, more accurate, and quicker manner. In addition, the robot functions faster than the multiple link prior art devices because there are less components that move to align the wafer handling robot with a process chamber. As a result of encompassing less components, fewer motors, and less complex power transfer mechanisms between components the present invention is more reliable.

Further increasing the reliability, efficiency, and speed of the present invention is the counterbalancing of the components. Counterbalancing of the components allows for faster translation of components because there is less resistance to movement. Less resistance to movement coincides with less stress and strain on the motor, power transfer mechanisms, and linkage assemblies resulting in less wear, debris production, and failure. Less wear, debris, and failure result in a higher throughput for each individual device while the small footprint of the present invention allows for more devices per floor space in a manufacturing facility, which further increases the throughput of the manufacturing facility.

The foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Furthermore, the order of steps in the method are not necessarily intended to occur in the sequence laid out. It is intended that the scope of the invention be defined by the following claims and their equivalents.

What is claimed is:

1. A robot comprising:
a substantially vertical linear track;
a bearing configured to translate along said linear track;
an elongate arm having opposing first and second ends, where said elongate arm is rotatably coupled to said bearing near said first end; and
a platform rotatably coupled to said elongate arm near said second end, where said platform is configured to receive a wafer handling robot.

2. The robot of claim 1, further comprising a linear drive coupled to said bearing, where said linear drive is configured to translate said bearing along said linear track.

3. The robot of claim 2, wherein said linear drive is selected from the group consisting of a worm screw mechanism; lead screw mechanism, ball screw mechanism, a rack-and-pinion mechanism; a stepper motor mechanism; a belt and pulley; a linear motor mechanism; a servo-pneumatic mechanism, hydraulic mechanism, and any combinations of the above.

4. The robot of claim 1, further comprising a rotary drive coupling said bearing to said first end, where said rotary drive is configured to rotate said elongate arm about an axis perpendicular to a longitudinal axis of said linear track.

5. The robot of claim 4, wherein said rotary drive is selected from the group consisting of a stepper motor, a servo motor, a hydrostatic actuator, a hydraulic actuator, and any combinations of the above.

6. The robot of claim 1, further comprising a stabilizing mechanism coupled to said platform and said elongate arm, where said stabilizing mechanism keeps said platform substantially perpendicular to a longitudinal axis of said linear track.

7. The robot of claim 6, wherein said stabilizing mechanism is selected from the group consisting of a pulley mechanism, a servo motor mechanism, a stepper motor mechanism, a hydrostatic mechanism, a hydraulic mechanism, and any combinations of the above.

8. The robot of claim 1, wherein said linear track has a longitudinal track length and said elongate arm has longitudinal arm length, and where said longitudinal track length and said longitudinal arm length are selected based on a desired operational envelope of said robot.

9. The robot of claim 1, further comprising a rotational counterbalance mechanism coupled to said elongate arm.

10. The robot of claim 9, wherein said rotational counterbalance mechanism is selected from the group consisting of a pulley mechanism, a spring mechanism, a pneumatic mechanism, a hydraulic mechanism, a mass counterbalance mechanism, and any combination of the above.

11. The robot of claim 1, further comprising a linear counterbalance mechanism.

12. The robot of claim 11, wherein said linear counterbalance mechanism is generated by a counterforce mechanism that is selected from the group consisting of: a pulley mechanism, a weight mechanism; a pneumatic mechanism, a vacuum mechanism a mass counterbalance mechanism, and any combination of the above.

13. The robot of claim 1, further comprising a operational envelope determined by the length of said elongated arm, the height of said linear track, and the maximum angle that said elongated arm can rotate.
